(19) United States
(12) Patent Application Publication
(10) Pub. No.: US 2022/0343278 A1
(43) Pub. Date: Oct. 27, 2022

(54) ARTIFICIAL INTELLIGENCE-BASED ATTACH RATE PLANNING FOR COMPUTER-BASED SUPPLY PLANNING MANAGEMENT SYSTEM

(71) Applicant: Dell Products L.P., Round Rock, TX (US)

(72) Inventors: Shibi Panikkar, Bangalore (IN); Rohit Gosain, Bangalore (IN)

(21) Appl. No.: 17/237,204

(22) Filed: Apr. 22, 2021

(51) Int. Cl. G06Q 10/08; G06Q 10/04; G06Q 30/06; G06N 20/00

(52) U.S. Cl. CPC G06Q 10/0875; G06Q 10/04; G06Q 30/0621; G06N 20/00

(57) ABSTRACT

Techniques for automated supply planning management are disclosed. For example, a method obtains a first data set representing historical data associated with a non-customizable system, a second data set representing historical data associated with a customizable base system, and a third data set representing historical data associated with components used to customize the customizable base system. The method pre-processes at least portions of the first data set, the second data set and the third data set, and then performs forecasting processes respectively on the pre-processed portions of the first data set, the second data set and the third data set. Results of the forecasting processes are correlated and the forecasting results associated with the third data set are modified based on variations in one or more of the forecasting results associated with the first data and the forecasting results associated with the second data.

### FIELD

The field relates generally to information processing systems, and more particularly to supply planning management within such information processing systems.

### BACKGROUND

Many original equipment manufacturers (OEMs) utilize a “configure to order” (CTO) model with respect to enabling customers to place orders for equipment. In the CTO model, a customer can configure their equipment for purchase in a customized manner, i.e., specifying the equipment component by component starting from a base package. That is, the OEM makes available a base package and the customer then adds components to the base package to customize the equipment. Each customer order then goes to the OEM's manufacturing group to be separately built.

An alternative ordering model is a “finished goods assembly” (FGA) model. In the FGA model, rather than enabling the customer to specify components for the equipment for purchase, the equipment is pre-configured typically with no component customization permitted by the customer. Typically, with the FGA model, the OEM utilizes a merge center where the equipment is assembled, and then shipped to the customer from the merge center.

### SUMMARY

Illustrative embodiments provide techniques for automated supply planning management within information processing systems.

For example, in an illustrative embodiment, a method comprises the following steps. The method obtains a first data set representing historical data associated with a non-customizable system, a second data set representing historical data associated with a customizable base system, and a third data set representing historical data associated with components used to customize the customizable base system. The method pre-processes at least portions of the first data set, the second data set and the third data set. The method performs forecasting processes respectively on the pre-processed portions of the first data set, the second data set and the third data set. The method correlates results of the forecasting processes and modifies the forecasting results associated with the third data set based on variations in one or more of the forecasting results associated with the first data and the forecasting results associated with the second data. The method generates a supply plan for components used to customize the customizable base system based on the modified forecasting results associated with the third data set.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

Advantageously, illustrative embodiments provide automated supply planning management that takes into account historical data for components obtained for customizing the base system in the context of a CTO-based ordering model. One or more illustrative embodiments utilize a machine learning algorithm to process data.

These and other illustrative embodiments include, without limitation, apparatus, systems, methods and computer program products comprising processor-readable storage media.

### BRIEF DESCRIPTION OF THE DRAWINGS

FIG. 1 illustrates an artificial intelligence-based configure-to-order supply planning management environment according to an illustrative embodiment.

FIG. 2A illustrates a process flow depicting artificial intelligence-based configure-to-order supply planning management according to an illustrative embodiment.

FIG. 2B illustrates sample data for use in artificial intelligence-based configure-to-order supply planning management according to an illustrative embodiment.

FIG. 3 illustrates a methodology for artificial intelligence-based configure-to-order supply planning management according to an illustrative embodiment.

FIG. 4 shows an example of a processing platform that may be utilized to implement at least a portion of an information processing system with artificial intelligence-based configure-to-order supply planning management functionalities according to an illustrative embodiment.

### DETAILED DESCRIPTION

While the CTO model gives OEM customers the most flexibility, there can be a significant number of permutations of component combinations that the customer can select from for the equipment. For example, if the equipment is a computer system such as a desktop or laptop, the customer may have options to choose from including different random access memory capacities (e.g., 4 GB RAM, 8 GB RAM or 16 GB RAM capacity), different hard drive capacities (e.g., 500 GB or 1 TB capacity), different graphic cards, etc. Thus, the base system or structure (sometimes referred to as the “base mod”) is the same from customer to customer, however, each customer will have different added components based on their own equipment needs. Because there are not usually any discernible ordering patterns in the CTO model, it is difficult to manage supply planning.

On the other hand, the FGA model enables relatively accurate demand planning since the systems are pre-configured and the OEM knows how many systems need to be manufactured and stocked. An OEM can review the FGA sales history by a given region to predict (forecast) demand with a seasonality input, resulting in reasonably accurate forecasting (e.g., 80-85% accuracy). Based on this forecasting, the OEM performs supply planning (e.g., what raw materials (e.g., components) are needed to be purchased and stocked for building the equipment). A bill of materials (BOM) can then be generated based on the forecasted FGAs, and purchase orders issued by the OEM to suppliers to purchase the forecasted quantity of components.

In contrast, with the CTO model, there is no pattern of the CTO purchase because of its dynamic nature. The OEM can forecast the number of total systems based on sales history (similar to FGA model) and therefore adequately predict the number of base packages (base mods) to order, but it is difficult to predict all the customer variations selected on top of the base packages. Nonetheless, the OEM still needs to purchase raw materials, e.g., components associated with customer-selectable options, and keep them available at the manufacturing location.

One manual approach to address this issue with the CTO model is to take the base package forecasting and “attach” different customer combinations as percentages based on subject matter expert (SME) knowledge, e.g., 4 GB RAM 35%, 8 GB RAM 45%, 16 GB RAM 20%, etc. This approach is called attach rate planning. For example, the attach rate can be calculated as a percentage by dividing the number of systems with the given component (e.g., 4 GB RAM, 8 GB RAM, or 16 GB RAM) by the number of systems, and then multiplying the quotient by 100. So with an attach rate of 35% for the 8 GB RAM component, this means that the SME is guessing that 35% of the systems that will be sold will include the 8 GB RAM option. Unfortunately, due to this manual process, the forecast accuracy of CTO products is typically less than 40%.

Illustrative embodiments overcome the above and other challenges associated with supply planning for CTO systems by taking into account historical data for components obtained for customizing the base package in the context of a CTO-based ordering model and using one or more machine learning (ML) algorithms. An ML algorithm is typically considered part of artificial intelligence (AI) technology where the computer-implemented algorithm learns from input data so as to improve subsequent output data.

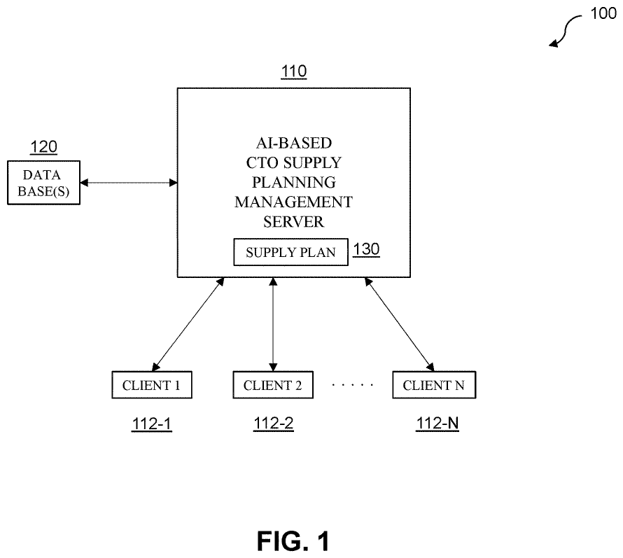

FIG. 1 illustrates an AI-based CTO supply planning management environment 100 according to an illustrative embodiment. Part(s) or all of AI-based CTO supply planning management environment 100 can be considered an information processing system. As shown, AI-based CTO supply planning management environment 100 comprises an AI-based CTO supply planning management server 110 with a plurality of client devices (clients) 112-1, 112-2, . . . , 112-N operatively coupled thereto. As will be explained in further detail below, AI-based CTO supply planning management server 110 inputs data from one or more data bases 120 including, but not limited to, one or more sets of historical data and generates a supply plan 130 (e.g., including, but not limited to, raw materials required for demand planning) that can be consumed or otherwise utilized by one or more of the plurality of client devices 112-1, 112-2, . . . , 112-N. For example, a client can be a purchasing system or department of the OEM and/or a component vendor.

Note that “demand planning” is forecasting customer demand while “supply planning” is the management of the inventory supply to meet the targets of the demand forecast. That is, supply planning seeks to fulfill the demand plan while meeting the OEM goals (e.g., financial and/or service objectives). A main challenge therefore is that while an SME can forecast customer demand relatively accurately with respect to an overall number of systems sold, the SME cannot adequately forecast the multitude of component customizations that will be selected by the customers in a CTO-based ordering environment, thus making it difficult to perform reasonably accurate supply planning.

Accordingly, AI-based CTO supply planning management server 110 is configured to accurately predict attaching components for a CTO system, rather than conventional SME-based percentage attach rate planning. Advantageously, AI-based CTO supply planning management server 110 is configured to perform automated attach rate planning by determining ratios/percentages in which the components will be attached to the CTO system by accounting for the total purchases not just the sales. In this manner, for example, accuracy can increase from less than 40% to 75 to 85% and the amount of safety stock (e.g., extra components purchased to accommodate for inaccurate planning) can be reduced.

Illustrative embodiments make use of the actual purchase history of raw material components from different vendors. More particularly, illustrative embodiments use a combination of a base model demand planning forecast and ML-generated results of the actual raw material purchase to calculate how much raw material will be needed for the CTO purchase for a given future time horizon (e.g., next few weeks, months, quarters, etc.).

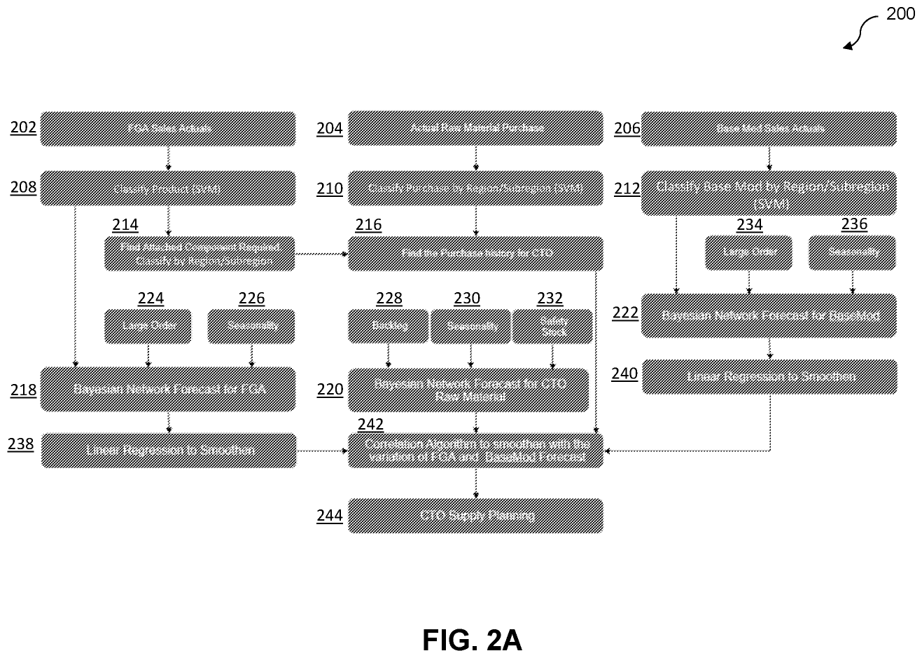

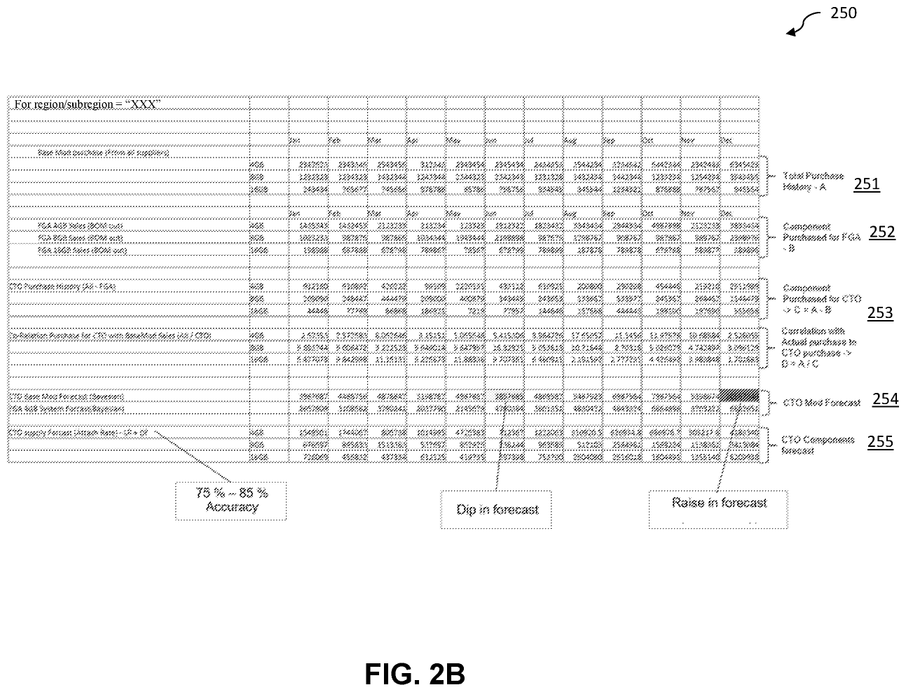

FIG. 2A illustrates a process flow 200 performed (in whole or at least in part) by AI-based CTO supply planning management server 110 in accordance with an illustrative embodiment. By way of a non-limiting example, it is assumed here that the system that is manufactured and sold is a computer system (e.g., desktop, laptop, etc.). In such an illustrative use case, it is to be understood that each computer system is made up of a base system or structure (base mod) that includes standard components such as a housing, a motherboard, a power supply, etc. In the CTO-based ordering system, each customer is able to customize the base mod configuration with selectable components such as, but not limited to, RAM, a graphics card, a hard drive, etc.

As shown in FIG. 2A, as input to the process flow 200, data 202 representing FGA sales actuals, data 204 representing actual raw material purchase, and data 206 representing base mod sales actuals are obtained. Generally, the data in the sets of data 202, 204 and 206 includes quantities. For example, such data can include, but is not limited to, the number of FGA-based systems sold, the number of CTO-based systems sold, the numbers of the CTO-based configurable components sold. In terms of AI-based CTO supply planning management server 110 in FIG. 1, data 202, 204 and 206 can be obtained from the one or more data bases 120 and/or from some other source(s).

“FGA sales actuals” refers to the sales data (e.g., quantities) for computer systems purchased in a “finished goods assembly” ordering system. Recall that, in the FGA ordering system, rather than enabling the customer to specify components for the equipment for purchase, the equipment is pre-configured typically with no component customization permitted by the customer. Thus, the computer system comes preconfigured with a housing, motherboard, power supply, RAM, graphics card, hard drive, etc. As such, data 202 represents sales data for FGA-based computer systems purchased over a predetermined historical time period.

“Base mod sales actuals” refers to sales data (e.g., quantities) for the components that constitute the base structure (base mod) of the computer systems purchased in a CTO ordering system. Thus, the base mod for the computer system comes with such standard components as a housing, a motherboard and a power supply. As such, data 204 represents sales data for the base mod portion of CTO-based computer systems purchased over the predetermined historical time period.

“Actual raw material purchase” refers to sales data (e.g., quantities) for the components that constitute the customizations of the base mod selected by the customers for the computer systems purchased in a CTO ordering system. Thus, the raw material refers to the selectable components such as RAM, a graphics card and a hard drive. As such, data 206 represents sales data for the customizable portions of the CTO-based computer systems purchased over the predetermined historical time period.

FIG. 2B illustrates sample data (quantities) and computations 250 for a given region/subregion illustrating parts of process flow 200. More particularly, the exemplary data reflects 4 GB, 8 GB, 16 GB FGA laptops and CTO-based laptops (e.g., Dell Inspirion™ laptop or some other computer system) according to an illustrative embodiment. Reference will be made to FIG. 2B as the steps of process flow 200 of FIG. 2A are described below.

Note that the sales data (202, 204, and 206) considered as input for process 200 can be filtered not only by the predetermined time period of interest but also based on the sales regions and/or subregions defined by the OEM. In some embodiments, AI-based CTO supply planning management server 110 queries the one or more databases 120 for the sales data for the predetermined historical time period and specific regions/subregions of interest. In addition, as shown in process flow 200 of FIG. 2A, the sets of data 202, 204 and 206 are respectively applied to classifiers 208, 210 and 212 which, in some embodiments, can each be in the form of a support vector machine (SVM). In machine learning (a specific area of AI), SVMs are supervised learning models with associated learning algorithms that analyze data for classification. In the case of classifier 208, 210 and 212, an SVM can be used for classifying products (components) by region and/or subregion as needed.

In step 214, process flow 200 identifies the components used for the FGA systems (i.e., finds attached component required and classified by region/subregion). In some embodiments, this can be done by AI-based CTO supply planning management server 110 digitally analyzing a bill of materials (BOM) for the standard FGA system to identify the subject components.

In step 216, process flow 200 finds the purchase history for the raw materials used for the CTO system. More particularly, this can be calculated by AI-based CTO supply planning management server 110 subtracting the quantities of material used for the FGA system (e.g., 252 in FIG. 2B) from total raw material purchase quantities (e.g., 251 in FIG. 2B). This calculation yields the quantity purchase history for the CTO system by product (component) and by region and/or subregion (e.g., 253 in FIG. 2B). This also enables a correspondence (ratio) to be determined between the actual purchase and the CTO purchase.

Next in process flow 200, forecasts are obtained for the FGA system in step 218, the CTO raw material in step 220, and the base mod system in step 222 (e.g., 254 and 255 in FIG. 2B). In some embodiments, a Bayesian network method is used to perform the forecasting in each of steps 218, 220 and 222. As shown, for FGA forecasting in step 218, in addition to the output of step 208 serving as input, additional input includes large order sales (e.g., sudden increase in orders) data 224 and seasonal sales (seasonality) data 226 which can be obtained from the one or more data bases 120. Similarly, for base mod forecasting in step 222, in addition to the output of step 212 serving as input, additional input includes large order sales data 234 and seasonal sales (seasonality) data 236 which also can be obtained from the one or more data bases 120. For CTO raw material forecasting in step 220, input includes backlog data 228 (e.g., current orders in the purchasing pipeline), seasonality data 230 and safety stock data 232 (recall safety stock is extra stock that is ordered to cover unanticipated scenarios) which can also be obtained from the one or more data bases 120. The Bayesian network (BN) method is considered a machine learning algorithm and provides a statistical scheme for probabilistic forecasting that can represent cause-effect relationships between variables, and gives more accurate forecasts as compared with other forecasting algorithms, e.g., linear algorithms. It is to be understood, however, that alternative forecasting methodologies (and/or combinations of forecasting methodologies) can be employed in other embodiments.

After the forecasting for the FGA system in step 218, the results are applied to a linear regression algorithm in step 238 to smoothen that predicted data set, for example, by statistically eliminating outliers from the data set to make patterns more noticeable. A similar linear regression smoothing is performed in step 240 on the predicted results from the base mode forecasting in step 222. Linear regression is considered a machine learning algorithm.

In step 242, the forecast results from FGA forecasting step 218 (smoothed in step 238), CTO raw material forecasting step 220, and base mod forecasting step 222 (smoothed in step 240) are applied to a correlation algorithm. In some embodiments, the correlation algorithm takes the median of the changes (variations) that occurred for the FGA forecast and the base mod forecast, and changes the percentage in the CTO forecast accordingly. For example, assume that the FGA forecast data is less than the actual current data, then this same variation will be applied for the CTO forecast and the CTO forecast data is equally reduced. The result of the correlation step 242 is the predicted material required based on the CTO forecast (referred to as the attach rate) which becomes the CTO supply plan (e.g., supply plan 130 in FIG. 1) and sent to a purchasing system/department or supplier(s) for purchase in step 244. Note that the purchasing system/department or supplier(s) can be one or more of the plurality of clients 112 in FIG. 1.

Advantageously, as illustratively described above, illustrative embodiments provide AI-based (machine learning) CTO supply planning management based on the actual purchase and correlated CTO, base mod and FGA forecasts, rather than the current demand planning and SME % of attach Rate. As such, supply planning accuracy increases from about 30-40% to about 75-80%.

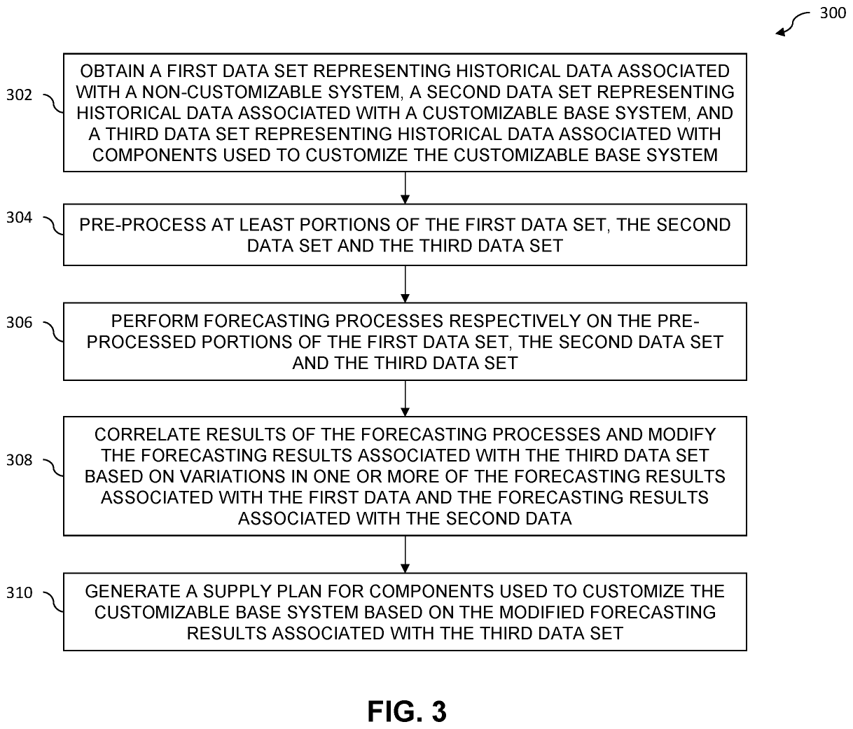

FIG. 3 illustrates a methodology 300 for artificial intelligence-based configure-to-order supply planning management according to an illustrative embodiment. Methodology 300 can be performed, for example, in AI-based CTO supply planning management server 110, and may be considered a broad representation of the embodiment of process flow 200 and other embodiments described herein, as well as other alternatives and variations. While not limited to process flow 200, for further clarity of understanding, steps of process flow 200 are referenced below as examples to the steps of methodology 300 where appropriate.

Step 302 obtains a first data set representing historical data associated with a non-customizable system (e.g., 202), a second data set representing historical data associated with a customizable base system (e.g., 206), and a third data set representing historical data associated with components used to customize the customizable base system (e.g., 204). Step 304 pre-processes at least portions of the first data set, the second data set and the third data set (e.g., 208 through 216). Step 306 performs forecasting processes respectively on the pre-processed portions of the first data set, the second data set and the third data set (e.g., 218, 222, 220).

Step 308 then correlates results of the forecasting processes and modifies the forecasting results associated with the third data set based on variations in one or more of the forecasting results associated with the first data and the forecasting results associated with the second data (e.g., step 242). Step 310 generates a supply plan for components used to customize the customizable base system based on the modified forecasting results associated with the third data set (step 244).

Illustrative embodiments have been described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing platforms comprising cloud and/or non-cloud computing and storage systems, as well as other types of processing systems comprising various combinations of physical and/or virtual processing resources. An information processing system may therefore comprise, by way of example only, at least one data center or other type of cloud-based system that includes one or more clouds hosting tenants that access cloud resources. Cloud-based systems may include one or more public clouds, one or more private clouds, or a hybrid combination thereof.

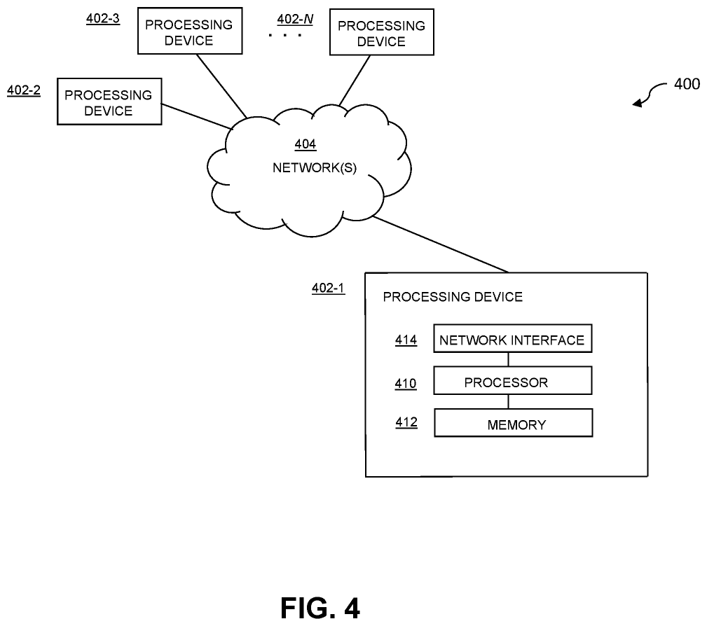

By way of one example, FIG. 4 depicts a processing platform 400 used to implement AI-based CTO supply planning management server 110, process flow 200, and/or methodology 300 according to an illustrative embodiment. More particularly, processing platform 400 is a processing platform on which a computing environment with functionalities described herein can be implemented.

The processing platform 400 in this embodiment comprises a plurality of processing devices, denoted 402-1, 402-2, 402-3, . . . , 402-N, which communicate with one another over network(s) 404. It is to be appreciated that the methodologies described herein may be executed in one such processing device 402, or executed in a distributed manner across two or more such processing devices 402. It is to be further appreciated that a server, a client device, a computing device or any other processing platform element may be viewed as an example of what is more generally referred to herein as a “processing device.” As illustrated in FIG. 4, such a device generally comprises at least one processor and an associated memory, and implements one or more functional modules for instantiating and/or controlling features of systems and methodologies described herein. Multiple elements or modules may be implemented by a single processing device in a given embodiment. Note that components described in the architectures depicted in the figures can comprise one or more of such processing devices 402 shown in FIG. 4. The network(s) 404 represent one or more communications networks that enable components to communicate and to transfer data therebetween, as well as to perform other functionalities described herein.

The processing device 402-1 in the processing platform 400 comprises a processor 410 coupled to a memory 412. The processor 410 may comprise a microprocessor, a microcontroller, an application-specific integrated circuit (ASIC), a field programmable gate array (FPGA) or other type of processing circuitry, as well as portions or combinations of such circuitry elements. Components of systems as disclosed herein can be implemented at least in part in the form of one or more software programs stored in memory and executed by a processor of a processing device such as processor 410. Memory 412 (or other storage device) having such program code embodied therein is an example of what is more generally referred to herein as a processor-readable storage medium. Articles of manufacture or computer program products comprising such computer-readable or processor-readable storage media are considered embodiments of the invention. A given such article of manufacture may comprise, for example, a storage device such as a storage disk, a storage array or an integrated circuit containing memory. The terms “article of manufacture” and “computer program product” as used herein should be understood to exclude transitory, propagating signals.

Furthermore, memory 412 may comprise electronic memory such as random-access memory (RAM), read-only memory (ROM) or other types of memory, in any combination. The one or more software programs when executed by a processing device such as the processing device 402-1 causes the device to perform functions associated with one or more of the components/steps of system/methodologies in FIGS. 1-3. One skilled in the art would be readily able to implement such software given the teachings provided herein. Other examples of processor-readable storage media embodying embodiments of the invention may include, for example, optical or magnetic disks.

Processing device 402-1 also includes network interface circuitry 414, which is used to interface the device with the networks 404 and other system components. Such circuitry may comprise conventional transceivers of a type well known in the art.

The other processing devices 402 (402-2, 402-3, . . . 402-N) of the processing platform 400 are assumed to be configured in a manner similar to that shown for computing device 402-1 in the figure.

The processing platform 400 shown in FIG. 4 may comprise additional known components such as batch processing systems, parallel processing systems, physical machines, virtual machines, virtual switches, storage volumes, etc. Again, the particular processing platform shown in this figure is presented by way of example only, and the system shown as 400 in FIG. 4 may include additional or alternative processing platforms, as well as numerous distinct processing platforms in any combination.

Also, numerous other arrangements of servers, clients, computers, storage devices or other components are possible in processing platform 400. Such components can communicate with other elements of the processing platform 400 over any type of network, such as a wide area network (WAN), a local area network (LAN), a satellite network, a telephone or cable network, or various portions or combinations of these and other types of networks.

Furthermore, it is to be appreciated that the processing platform 400 of FIG. 4 can comprise virtual (logical) processing elements implemented using a hypervisor. A hypervisor is an example of what is more generally referred to herein as “virtualization infrastructure.” The hypervisor runs on physical infrastructure. As such, the techniques illustratively described herein can be provided in accordance with one or more cloud services. The cloud services thus run on respective ones of the virtual machines under the control of the hypervisor. Processing platform 400 may also include multiple hypervisors, each running on its own physical infrastructure. Portions of that physical infrastructure might be virtualized.

As is known, virtual machines are logical processing elements that may be instantiated on one or more physical processing elements (e.g., servers, computers, processing devices). That is, a “virtual machine” generally refers to a software implementation of a machine (i.e., a computer) that executes programs like a physical machine. Thus, different virtual machines can run different operating systems and multiple applications on the same physical computer. Virtualization is implemented by the hypervisor which is directly inserted on top of the computer hardware in order to allocate hardware resources of the physical computer dynamically and transparently. The hypervisor affords the ability for multiple operating systems to run concurrently on a single physical computer and share hardware resources with each other.

It was noted above that portions of the computing environment may be implemented using one or more processing platforms. A given such processing platform comprises at least one processing device comprising a processor coupled to a memory, and the processing device may be implemented at least in part utilizing one or more virtual machines, containers or other virtualization infrastructure. By way of example, such containers may be Docker containers or other types of containers.

The particular processing operations and other system functionality described in conjunction with FIGS. 1-4 are presented by way of illustrative example only, and should not be construed as limiting the scope of the disclosure in any way. Alternative embodiments can use other types of operations and protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It should again be emphasized that the above-described embodiments of the invention are presented for purposes of illustration only. Many variations may be made in the particular arrangements shown. For example, although described in the context of particular system and device configurations, the techniques are applicable to a wide variety of other types of data processing systems, processing devices and distributed virtual infrastructure arrangements. In addition, any simplifying assumptions made above in the course of describing the illustrative embodiments should also be viewed as exemplary rather than as requirements or limitations of the invention.

What is claimed is:

1. An apparatus comprising:
at least one processing platform comprising at least one processor coupled to at least one memory, the at least one processing platform, when executing program code, is configured to:
obtain a first data set representing historical data associated with a non-customizable system, a second data set representing historical data associated with a customizable base system, and a third data set representing historical data associated with components used to customize the customizable base system;
pre-process at least portions of the first data set, the second data set and the third data set;
perform forecasting processes respectively on the pre-processed portions of the first data set, the second data set and the third data set;
correlate results of the forecasting processes and modify the forecasting results associated with the third data set based on variations in one or more of the forecasting results associated with the first data and the forecasting results associated with the second data; and
generate a supply plan for components used to customize the customizable base system based on the modified forecasting results associated with the third data set.

2. The apparatus of claim 1, wherein pre-processing at least portions of the first data set, the second data set and the third data set further comprises performing a machine learning classification process on each of the portions of the first data set, the second data set and the third data set.

3. The apparatus of claim 1, wherein pre-processing at least portions of the first data set, the second data set and the third data set further comprises identifying, from the first data set, a subset of the third data set for use in the forecasting process.

4. The apparatus of claim 1, wherein the at least one processing platform, when executing program code, is further configured to perform a smoothing process on respective results of the forecasting processes of the first data set and the second data set.

5. The apparatus of claim 4, wherein the smoothing process comprises a linear regression algorithm.

6. The apparatus of claim 1, wherein one or more of the forecasting processes comprises a Bayesian network-based process.

7. The apparatus of claim 1, wherein the at least one processing platform, when executing program code, is further configured to send the supply plan to one or more client devices operatively coupled to the at least one processing platform.

8. A method comprising:
obtaining a first data set representing historical data associated with a non-customizable system, a second data set representing historical data associated with a customizable base system, and a third data set representing historical data associated with components used to customize the customizable base system;
pre-processing at least portions of the first data set, the second data set and the third data set;
performing forecasting processes respectively on the pre-processed portions of the first data set, the second data set and the third data set;
correlating results of the forecasting processes and modify the results associated with the third data set based on variations in one or more of the results associated with the first data and the results associated with the second data; and
generating a supply plan for components used to customize the customizable base system based on the modified results associated with the third data set;
wherein the steps are executed by at least one processing platform comprising at least one processor coupled to at least one memory configured to execute program code.

9. The method of claim 8, wherein pre-processing at least portions of the first data set, the second data set and the third data set further comprises performing a machine learning classification process on each of the portions of the first data set, the second data set and the third data set.

10. The method of claim 8, wherein pre-processing at least portions of the first data set, the second data set and the third data set further comprises identifying, from the first data set, a subset of the third data set for use in the forecasting process.

11. The method of claim 8, further comprising performing a smoothing process on respective results of the forecasting processes of the first data set and the second data set.

12. The method of claim 11, wherein the smoothing process comprises a linear regression algorithm.

13. The method of claim 8, wherein one or more of the forecasting processes comprises a Bayesian network-based process.

14. The method of claim 8, further comprising sending the supply plan to one or more client devices operatively coupled to the at least one processing platform.

15. A computer program product comprising a non-transitory processor-readable storage medium having stored therein program code of one or more software programs, wherein the program code when executed by the at least one processing platform causes the at least one processing platform to:
obtain a first data set representing historical data associated with a non-customizable system, a second data set representing historical data associated with a customizable base system, and a third data set representing historical data associated with components used to customize the customizable base system;
pre-process at least portions of the first data set, the second data set and the third data set;
perform forecasting processes respectively on the pre-processed portions of the first data set, the second data set and the third data set;
correlate results of the forecasting processes and modify the results associated with the third data set based on variations in one or more of the results associated with the first data and the results associated with the second data; and
generate a supply plan for components used to customize the customizable base system based on the modified results associated with the third data set.

16. The computer program product of claim 15, wherein pre-processing at least portions of the first data set, the second data set and the third data set further comprises performing a machine learning classification process on each of the portions of the first data set, the second data set and the third data set.

17. The computer program product of claim 15, wherein pre-processing at least portions of the first data set, the second data set and the third data set further comprises identifying, from the first data set, a subset of the third data set for use in the forecasting process.

18. The computer program product of claim 15, further comprising performing a smoothing process on respective results of the forecasting processes of the first data set and the second data set.

19. The computer program product of claim 18, wherein the smoothing process comprises a linear regression algorithm.

20. The computer program product of claim 15, wherein one or more of the forecasting processes comprises a Bayesian network-based process.
